(19) United States
(12) Patent Application Publication
(10) Pub. No.: US 2015/0195551 A1
(43) Pub. Date: Jul. 9, 2015

(54) PROGRAMMABLE VARIABLE BLOCK SIZE MOTION ESTIMATION PROCESSOR

(71) Applicant: SQUID DESIGN SYSTEMS PVT LTD, Hyderabad (IN)

(72) Inventors: Suresh Babu P V, Hyderabad (IN); Satyanarayana Uppalapati, Hyderabad (IN); Govinda Siva Prasad Vabbalareddy, Hyderabad (IN); Kishor Simma, Hyderabad (IN); Vineeth Kumar Paruchuri, Hyderabad (IN)

(73) Assignee: SQUID DESIGN SYSTEMS PVT LTD, Hyderabad (IN)

(21) Appl. No.: 14/413,711

(22) PCT Filed: Jul. 8, 2013
(86) PCT No.: PCT/IB2013/055568

§ 371 Date: Jan. 9, 2015

(30) Foreign Application Priority Data
Jul. 9, 2012 (IN) 2759/CHE/2012

(51) Int. Cl. H04N 19/433; H04N 19/567; H04N 19/597; H04N 19/105

(52) U.S. Cl. CPC H04N 19/433; H04N 19/105; H04N 19/567; H04N 19/597

(57) ABSTRACT

A method of performing a motion estimation search utilizing a motion estimation accelerator in a video processing system comprises a method of transmitting an original pixel data to at least one memory bank of a motion estimation engine and calculates the distortion value between the original pixel data and a predicted pixel data by a sum of absolute difference engine. Then the calculated distortion value and a plurality of predefined parameters such as cost factor are analyzed by an analyzer to obtain a minimum rate distortion cost. Further performs a cost based search in a plurality of pixel partition modes of a cost factor added pixel data and conducts an n stage motion estimation of a plurality of sub partitions in a single stretch and also performs a motion estimation process at different pipeline stages in a single pixel partition to provide a best search point of subsequent pixel partitions.

### TECHNICAL FIELD

The present invention generally relates to video processing systems. More particularly the present invention relates to a method and system method of performing motion estimation search utilizing a motion estimation accelerator in video processing systems.

### BACKGROUND OF THE INVENTION

Generally, to transmit video data over band-limited communication channels and to store on compact storage devices an efficient data compression technique is required to represent the video data. The video data transfer is in the form of bit streams comprising a series of two dimensional images consisting of a number of horizontally and vertically placed pixels.

Typically, to remove the temporal redundancy between the consecutive images of video data an efficient motion estimation algorithm is required to encode any video data. There are different types of encoding standards among them one of the methods conventionally used for the compression of video data into macro blocks is inter/intra block coding. Each individual macro block is either coded as intra/inter, wherein intra block coding is used for spatial correlation and inter block coding for temporal correlation. Inter block coding is mostly used for predicting the previous reference frames of macro blocks whereas the intra block coding is used for macro blocks with low spatial activity.

The other conventional method used for encoding the video data is motion estimation at block levels. The image is divided into macro blocks and each macro block is searched across the previous reference frames to find out the best match and sent to the decoder using motion vector. Therefore to select the best motion vector a rate-distortion cost is used in the set of motion vectors available in the search window. But the above video coding standard techniques used to represent the best match information the number of divisions of macro blocks are limited up to the size of the macro block.

Typically, to overcome the above mentioned video coding technique for a limited block size of a motion estimation search, other methods have been used for finding the best match information. These methods are capable of finding the best match at different block sizes and are also able to use the n-stage motion estimation search patterns to find the best motion vector. Thus the process of finding this n-stage motion estimation search is possible by calculating the cost factor of individual partition and the entire macro block. But the conventional n-stage search method used for finding the best search point is able to represent only a single motion vector in a single stretch.

In the light of aforementioned limitations, there exists a need of establishing two types of configuration registers in a motion estimation accelerator for calculating the cost factor of motion estimation search points and partitioning multiple motion searches in a single stretch for flexibly predicting data anywhere from the memory space and also switching the motion estimation engine across different pipeline stages of motion estimation process for activating and deactivating the multiple partitions in a single macro block time slot.

### BRIEF SUMMARY OF THE INVENTION

The following presents a simplified summary of the disclosure in order to provide a basic-does not identify key/critical elements of the invention or delineate the scope of the invention. Its sole purpose is to present some concepts disclosed herein in a simplified form as a prelude to the more detailed description that is presented later.

Exemplary embodiment of the present invention is directed to a method of performing motion estimation search utilizing a motion estimation accelerator in a video processing system. According to an exemplary embodiment of the present invention, the method includes transmitting an original pixel data to at least one memory bank of a motion estimation engine. The motion estimation engine is used to calculate the best search point among a predicted pixel data.

According to an exemplary embodiment of the present invention the method includes calculating a distortion value between the original pixel data and a predicted pixel data by a sum of absolute difference engine (SAD) configured in the motion estimation engine.

According to an exemplary embodiment of the present invention the method includes analysing the distortion value and a plurality of predefined parameters by an analyser configured in the motion estimation engine to obtain a minimum rate distortion cost. The analyser configured to add a cost factor and a plurality of parameters to the distortion value calculated by the sum of absolute difference engine and perform a cost based search in a plurality of pixel partition modes of a cost factor added pixel data.

According to an exemplary embodiment of the present invention the method includes analysing the distortion value and a plurality of predefined parameters by an analyser configured in the motion estimation engine to obtain a minimum rate distortion cost. The analyser configured to conduct an n stage motion estimation of a plurality of sub partitions corresponding to the plurality of pixel partition in a single stretch and seamlessly switch across different pipeline stages of the motion estimation process in single pixel partition and provide a best search point of subsequent pixel partitions associated to the plurality of pixel partitions.

### BRIEF DESCRIPTION OF DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 is a diagram depicting a connectivity of the motion estimation engine with a host processor and a direct memory access controller.

FIG. 2 is a diagram depicting a detailed interface of a motion estimation engine.

FIG. 3 is a diagram depicting an overview of a motion estimation engine.

FIG. 4 is a diagram depicting the search pattern of a motion estimation task in horizontal dimension.

FIG. 5 is a diagram depicting the search pattern of a motion estimation task in vertical dimension.

FIG. 6 is a diagram depicting the search pattern of a motion estimation task in both horizontal and vertical dimensions.

FIG. 7 is a diagram depicting the search pattern of a motion estimation task in horizontal, vertical and depth dimensions.

FIG. 8 is a diagram depicting the motion estimation search pattern using cost factors.

FIG. 9 is a flow diagram depicting the cost based 3-dimensional motion search in motion estimation engine.

FIG. 10 is a diagram depicting the task executed in a motion estimation engine.

FIG. 11 is a diagram depicting the first step of a motion estimation search in first case.

FIG. 12 is a diagram depicting the second step of a motion estimation search in first case.

FIG. 13 is a diagram depicting the first step of a motion estimation search in second case.

FIG. 14 is a diagram depicting the second step of a motion estimation search in second case.

FIG. 15 is a flow diagram depicting the N-stage motion search in a host processor using motion estimation engine.

FIG. 15a is a flow diagram depicting the interrupt service routine for the first stage of motion search.

FIG. 15b is a flow diagram depicting the interrupt service routine for the second stage of motion search.

FIG. 15c is a flow diagram depicting the interrupt service routine for the third stage of motion search.

FIG. 15d is a flow diagram depicting the interrupt service routine for Nth stage of motion search.

FIG. 16 is a flow diagram depicting the process of finding the best partition. When motion estimation engine is configured in a 16×16 mode.

FIG. 16a is a flow diagram depicting the interrupt routine of motion estimation engine, when ME engine is configured in 16×16 mode to find out best partition.

FIG. 17 is a diagram depicting the process of finding the best match of upper partition and lower partition in a 16×8 mode.

FIG. 18 is a diagram depicting the process of finding the best match of sub partitions in an 8×8 mode.

FIG. 19 is a flow diagram depicting the process of switching motion estimation engine across 3-pipeline stages of motion estimation in a single macro block time slot.

FIG. 19a is a flow diagram depicting the interrupt routine of motion estimation engine for integer pixel ME pipeline stage.

FIG. 19b is a flow diagram depicting the interrupt routine of motion estimation engine for half-pixel ME pipeline stage.

FIG. 19c is a flow diagram depicting the interrupt routine of motion estimation engine for quarter-pixel ME pipeline stage.

FIG. 20 is a flow diagram depicting the process of N-stage motion search when only one interrupt facility is available in a motion estimation engine.

FIG. 20a is a flow diagram depicting about the interrupt service routine of an N-stage motion search.

FIG. 20b is a flow diagram depicting about the N−1 stages of motion search performed by the complex state machine.

FIG. 20c is a flow diagram depicting about the Nth stage motion search performed by the complex state machine.

FIG. 21 is a diagram depicting the process of activating and deactivating the region based motion search in 8×8 mode.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

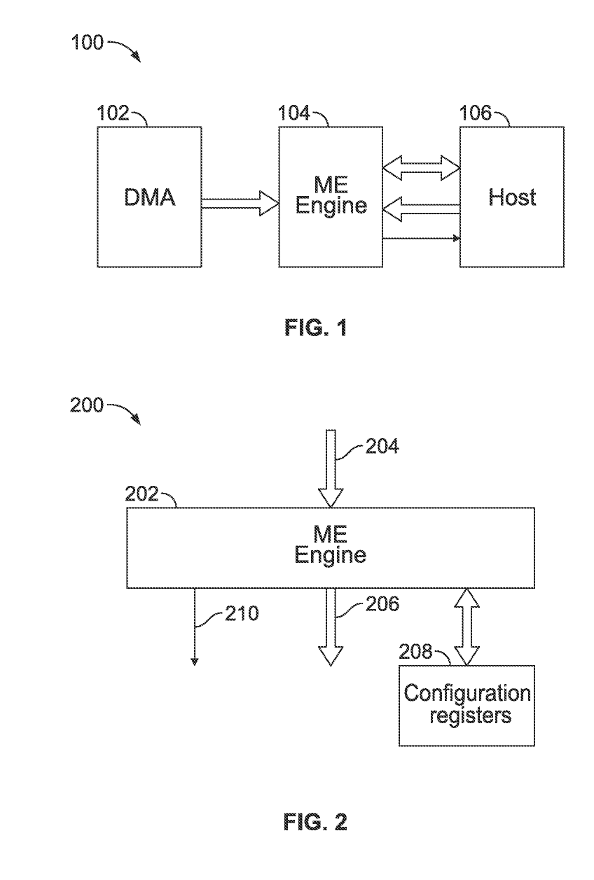

Referring to FIG. 1 is a diagram 100 depicting a connectivity of the motion estimation engine with a host processor and a direct memory access controller. According to a non limiting exemplary embodiment of the present subject matter, the diagram depicts a direct memory access 102 and a host 106 connected to a motion estimation engine 104 to calculate a best search point.

In accordance with a non limiting exemplary implementation of the present subject matter, the direct memory access 102 coupled to the motion estimation engine 104 transfers the original pixel data to one of 8 memory banks of the motion estimation engine 104. The host 106 coupled to the motion estimation engine 104 transfers the predicted pixel data and a multiple parameters including but not limited to as mode, cost factors and original data memory bank number and the like to the motion estimation engine 104 for calculating the sum of absolute difference value and the rate distortion cost. The results such as minimum rate distortion cost, minimum sum of absolute difference and the like obtained from the motion estimation engine 104 are further transferred to the host 106.

Referring to FIG. 2 is a diagram 200 depicting a detailed interface of a motion estimation engine. According to a non limiting exemplary embodiment of the present subject matter, the diagram 200 depicts connectivity between the configuration registers 208 and the motion estimation engine 202.

In accordance with a non limiting exemplary implementation of the present subject matter, a data bus 204 connected to the motion estimation engine 202 receives the original pixel data and the data bus 206 connected to the motion estimation engine 202 receives the predicted pixel data. The original pixel data and the predicted pixel data received from their respective data bus 204 and 206 are utilized to calculate the sum of absolute difference value or distortion value through a sum of absolute difference engine configured in the motion estimation engine 202. The distortion value obtained from the sum of absolute difference engine is further transmitted to an analyser present in the motion estimation engine 202 for calculating the rate distortion cost. The configuration registers 208 transmit parameters such as mode, cost factors and original data memory bank number and the like to the analyser for calculating the rate distortion cost by analysing the distortion value and the plurality of parameters such as mode, cost factors and original data memory bank number and the like. The minimum rate distortion cost and minimum sum of absolute difference and the like obtained from the analyser are transmitted to the host through the configuration registers 208 interfacing with the motion estimation engine 202. Thus an interrupt 210 interfacing the motion estimation engine 202 provides a user defined interrupt to the host device after completing the motion estimation process.

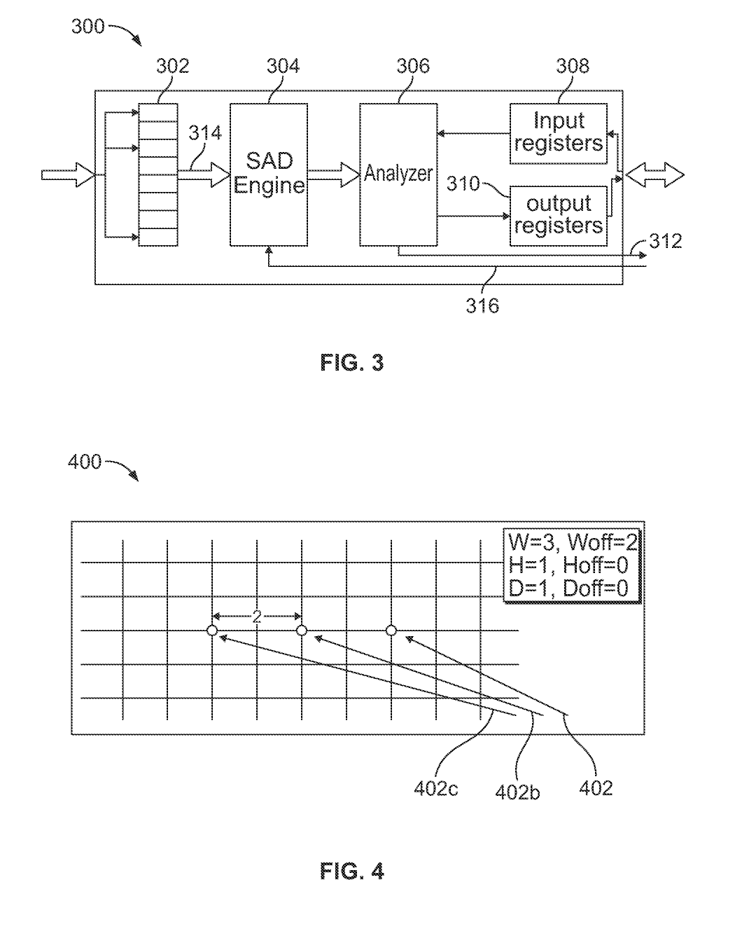

Referring to FIG. 3 is a diagram 300 depicting an overview of a motion estimation engine. According to a non limiting exemplary embodiment of the present subject matter, the motion estimation engine includes a memory bank 302, a sum of absolute difference engine 304, an analyser 306, input register 308 and output registers 310 constituting the configuration register and a prediction data bus 312 and an original data bus 314 connected to the sum of absolute difference engine 304 for calculating the distortion value and an interrupt 316 generated from the analyser 306 transmitted as an interrupt to the host processor after completing the motion estimation process.

In accordance with a non limiting exemplary implementation of the present subject matter, the original pixel data is transmitted from the direct memory access to the memory banks 302 configured in the motion estimation engine and further transferred to the sum of absolute difference engine 304 through an original data bus 314. The predicted pixel data is transmitted from the internal memory of the host to a sum of absolute difference engine 304 through a prediction data bus 312 for calculating the distortion value between the original pixel data and the predicted pixel data. The calculated distortion value is further transmitted to an analyser 306 for calculating the rate distortion cost by inputting the predefined parameters such as mode, cost factors and original data memory bank number and the like from the input register 308. The cost factor value added from the input register 308 calculates the best search point by providing a minimum rate distortion cost and transmits the minimum rate distortion cost value to the host through an output registers 310 by providing an interrupt signal 316 to the host.

Referring to FIG. 4 is a diagram 400 depicting the search pattern of a motion estimation task in horizontal dimension. According to a non limiting exemplary embodiment of the present subject matter, the programmable motion estimation accelerator is capable of calculating the best search point in different block sizes such as 16×16 search patterns, 16×8 search patterns, 8×16 search patterns and so on are programmed by the motion estimation accelerator through an input configuration registers whose search pattern is represented in horizontal dimensions.

In accordance with a non limiting exemplary implementation of the present subject matter, the search pattern depicts a width (W, i.e., number of steps in width), a vertical (H, i.e., number of steps in vertical), a depth (D, i.e., number of steps in depth), a width offset (Woff is the width offset in terms of pixels), a height offset (Hoff is the height offset in terms of lines) and a depth offset (Doff is the depth offset in terms of pixels) values to represent the search pattern of a motion estimation task in horizontal dimensions. For example to represent the search points 402a, 402b and 402c over a horizontal search pattern, the number of steps in width are considered as three, number of steps in vertical are considered as one, number of steps in depth are considered as one and width offset in terms of pixels is considered as two and height offset in terms of lines and depth offset in terms of pixels are considered as zero.

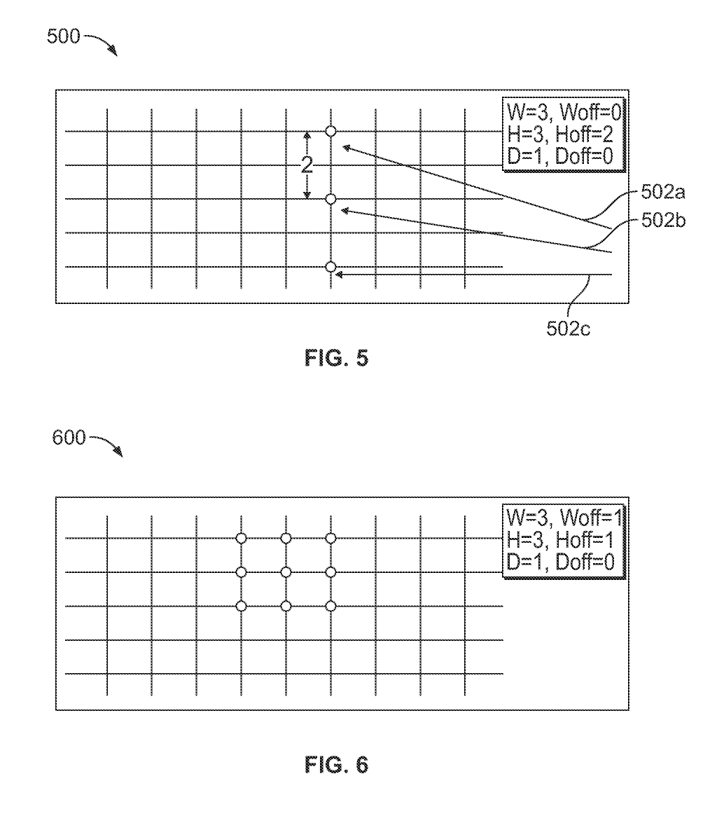

Referring to FIG. 5 is a diagram 500 depicting the search pattern of a motion estimation task in vertical dimension. According to a non limiting exemplary embodiment of the present subject matter, the programmable motion estimation accelerator is capable of calculating the best search point in different block sizes such as 16×16 search patterns, 16×8 search patterns, 8×16 search patterns and so on are programmed by the motion estimation accelerator through input configuration registers whose search pattern is represented in vertical dimensions.

In accordance with a non limiting exemplary implementation of the present subject matter, the search pattern includes a width (W, i.e., number of steps in width), a vertical (H, i.e., number of steps in vertical), a depth (D, i.e., number of steps in depth), a width offset (Woff is the width offset in terms of pixels), a height offset (Hoff is the height offset in terms of lines) and depth offset (Doff is the depth offset in terms of pixels) values to represent the search pattern of a motion estimation task in vertical dimensions. For example to represent the search points 502a, 502b and 502c over a vertical search pattern, the number of steps in width are considered as one, number of steps in vertical are considered as three, number of steps in depth are considered as one and the width offset in terms of pixels and depth offset in terms of pixels are considered as zero and the height offset in terms of lines is considered as two.

Referring to FIG. 6 is a diagram 600 depicting the search pattern of motion estimation task in both horizontal and vertical dimensions. According to a non limiting exemplary embodiment of the present subject matter, the programmable motion estimation accelerator is capable of calculating the best search point in different block sizes such as 16×16 search patterns, 16×8 search patterns, 8×16 search patterns and so on are programmed by the motion estimation accelerator through input configuration registers whose search pattern is represented in both vertical and horizontal dimensions.

In accordance with a non limiting exemplary implementation of the present subject matter, the search pattern includes a width (W, i.e., number of steps in width), a vertical (H, i.e., number of steps in vertical), a depth (D, i.e., number of steps in depth), a width offset (Woff is the width offset in terms of pixels), a height offset (Hoff is the height offset in terms of lines) and depth offset (Doff is the depth offset in terms of pixels) values to represent the search pattern of a motion estimation task in both vertical and horizontal dimensions. For example to represent the search points in both horizontal and vertical dimensions, the number of steps in width and the number of steps in vertical are considered as three, number of steps in depth are considered as one and the depth offset in terms of pixels is considered as zero and the height offset in terms of lines and the width offset in terms of pixels are considered as one.

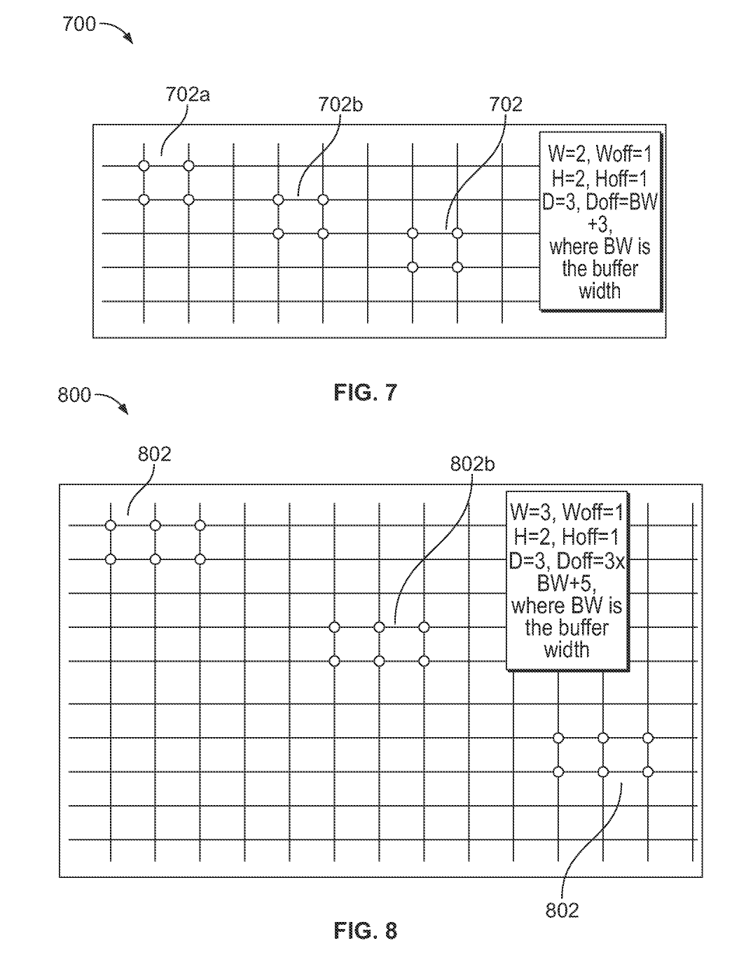

Referring to FIG. 7 is a diagram 700 depicting the search pattern of motion estimation task in horizontal, vertical and depth dimensions. According to a non limiting exemplary embodiment of the present subject matter, the programmable motion estimation accelerator is capable of calculating the best search point in different block sizes such as 16×16 search patterns, 16×8 search patterns, 8×16 search patterns and so on are programmed by motion estimation accelerator through input configuration registers whose search pattern is represented in horizontal, vertical and depth dimensions.

In accordance with a non limiting exemplary implementation of the present subject matter, the search pattern includes a width (W, i.e., number of steps in width), a vertical (H, i.e., number of steps in vertical), a depth (D, i.e., number of steps in depth), a width offset (Woff is the width offset in terms of pixels), a height offset (Hoff is the height offset in terms of lines) and depth offset (Doff is the depth offset in terms of pixels) values to represent the search pattern of a motion estimation task in horizontal, vertical and depth dimensions. For example to represent the search points of a plurality of pixel partitions 702a, 702b and 702c in horizontal, vertical and depth dimensions, the number of steps in width and number of steps in vertical are considered as two, number of steps in depth are considered as three and the height offset in terms of lines and width offset in terms of pixels are considered as one and the depth offset in terms of pixels is considered as the addition of buffer width with three (i.e., Doff=BW+3, where BW is the buffer width).

According to a non limiting exemplary embodiment of the present subject matter, the programmer can provide the weight cost factor of each individual search point in the three dimension motion estimation search pattern. The motion estimation accelerator includes two types of configuration registers such as two dimensional cost array register file “Cost_Array[M][N]” where M represents the maximum number of steps supported in vertical dimension and N represents the maximum number of steps supported in depth dimensions and a two dimensional cost-offset array register file “Cost_offset[2][N]” where N represents the maximum number of steps supported in depth dimensions to calculate the cost factors of motion estimation search points.

Referring to FIG. 8 is a diagram 800 depicting the motion estimation search pattern using cost factors. According to a non limiting exemplary embodiment of the present subject matter, the motion estimation search pattern depicts partitions 802a, 802b and 802c.

In accordance with a non limiting exemplary implementation of the present subject matter, the search pattern included in the process determines the rate distortion cost value calculated for each search point by using the cost factor value C (k, j, i) and the sum of absolute difference value S (k, j, i) through an equation R (k, j, i)=S (k, j, i)+C (k, j, i) where k represents the horizontal dimensions, j represents the vertical dimensions and i represents the depth dimensions. For example the motion estimation search pattern 800 is depicted by assigning the number of steps in width and number of steps in depth as three (W=3 and D=3), number of steps in vertical as two (H=2), the width offset in terms of pixels and height offset in terms of lines are considered as one (Woff=l and Hoff=1) and the depth offset in terms of pixels is considered as the addition of three times multiplied buffer width with five (Doff=3×BW+5, where BW is the buffer width).

According to a non limiting exemplary embodiment of the present subject matter, the search pattern 800 including partition or search point 802a represents the rate distortion cost value as R(0,0,0)=S(0,0,0)+C(0,0,0) which is depicted from the above general rate distortion cost equation where k, j and i values are represented as zero. Similarly the partition or search point 802c represents the rate distortion cost value as R(2,1,2)=S(2,1,2)+C(2,1,2) which is depicted from the above general rate distortion cost equation where k value i.e., horizontal dimension is considered as two (k=2), j value i.e., vertical dimension is considered as one 0=1) and the i value i.e., depth dimension is considered as two (i=2). So the rate distortion cost value is calculated for each individual search point in the multiple partitions placed in different dimensions over a motion estimation search point.

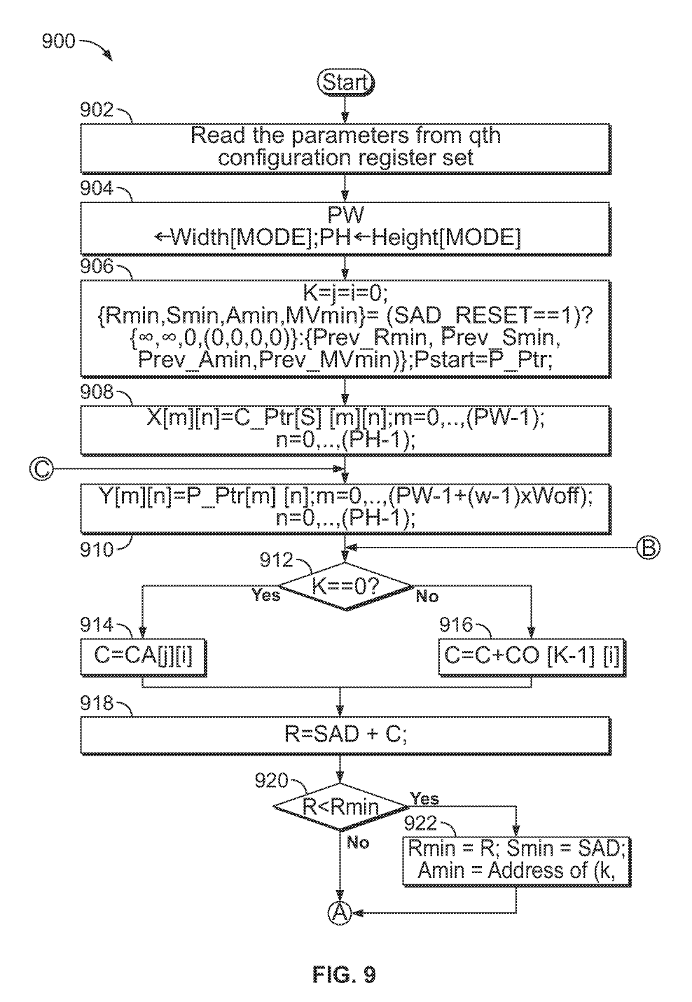

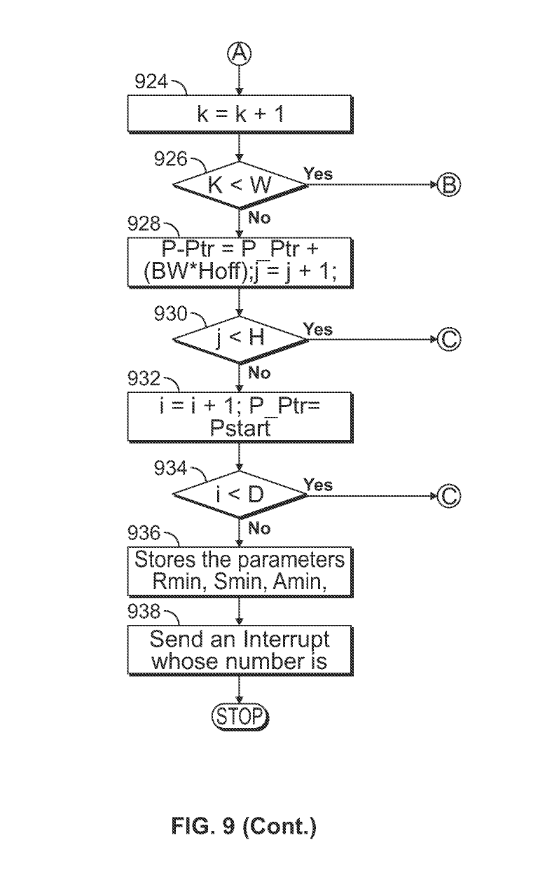

Referring to FIG. 9 is a flow diagram 900 depicting the cost based 3-dimensional motion search in motion estimation engine. According to a non limiting exemplary embodiment of the present subject matter, the method of flow diagram 900 depicts about the process of calculating the cost based 3-dimensional motion search.

In accordance with a non limiting exemplary implementation of the present subject matter, the method for calculating the cost based 3-dimensional motion search starts at step 902 by reading the parameters such as number of steps in width (W), number of steps in vertical (H), number of steps in depth (D), width offset in terms of pixels (Woff), height offset in terms of lines (Hoff), depth offset in terms of pixels (Doff), prediction data block in terms of pixels (BW), cost array (CA[H][D]), cost offset array (CO[2][D]), original data buffer number (S), pointer to prediction data (pptr), partition mode (MODE) and interrupt service routine number (INTR_NUM) and like from qth configuration register set and also assigns the partition mode of a width value to PW and partition mode of height value to PH at step 904. Initially k, j and i values are set to zero to calculate the minimum rate distortion cost (Rmin), minimum sum of absolute difference value (SADmin), address of the best search point (Amin) and motion vector information of best search point (MVmin) at step 906 by using the conditional parameter in the equation as (SAD_RESET==1)? {oo,oo,0,(0,0,0,0)}: {Prev Rmin, Prev Smin, Prev Amin, Prev MVmin}; which determines that when a reset register (SAD_RESET) is set to one the value of {Rmin, Smin, Amin, MVmin} will be {∞,∞,0,(0,0,0,0)} or else the value of {Rmin, Smin, Amin, MVmin} will be the previous values which represent the best search point {Prev Rmin, Prev Smin, Prev Amin, Prev MVmin} and also the Pstart is assigned with a pointer of prediction data (P Ptr) at step 906.

According to a non limiting exemplary embodiment of the present subject matter, at step 908 an array of original data (C_Ptr[S][m][n]) is assigned to an array of variable X[m][n] where m represents the values from 0 to (PW−1) and n represents the values from 0 to (PH−1). Similarly an array of prediction data (P_Ptr[m][n]) is assigned to an array of variable Y[m][n] where m represents the values from 0 to (PW−1+(W−1)×Woff) and n represents the values from 0 to (PH−1) at step 910. Further the cost based 3-dimension motion search includes a condition k==0 at step 912, if the condition provided in the step 912 is true an array of cost array (CA[j][i]) value is assigned to cost factor (C) at step 914 or else the previous cost factor (C) value is added to an array of cost offset (C+CO[k−1][i]) and is updated to the cost factor at step 916.

In accordance with a non limiting exemplary implementation of the present subject matter, the sum of absolute difference value is calculated by the equation mentioned in the step 918 and also the rate distortion cost value is calculated by adding the sum of absolute difference value to the cost factor value. At step 920 again a condition is provided by the cost based 3-dimensional motion search as R<Rmin, if the provided condition is true the rate distortion cost (R) value is assigned to Rmin, sum of absolute difference value is assigned to Smin, address of (k, j, i) point is assigned to Amin and (k, j, i, 0) point is assigned to MVmin at step 922 or else the k value is incremented by one as k=k+1 at step 924 and even after assigning the values at step 922 the process continues with step 924. Further after incrementing the k value at step 924 a condition is provided as K<W (i.e., k value is less than number of steps in width) at step 926, if the condition provided at step 926 is true the process goes back to the step 912 and if it is false the step 928 is continued by calculating the pointer to prediction data as P Ptr=P_Ptr+(BW×Hoff); and in the same step the j value is incremented by one. At step 930 a condition that j<H (i.e., j value is less than number of steps in vertical) is provided, if the condition is true the process goes back to step 910 and if the condition is false the process continues with the step 932 by incrementing the value of i by one and assigning the Pstart+(i×Doff) value to P Ptr. Again at step 934 a condition that i<D (i.e., i value is less than number of steps in depth) is provided, if the given condition is true the process goes back to step 910 and if it is false the process continues with the step 936 by storing the parameters Rmin, Smin, Amin and MVmin in the qth configuration register set and sends an interrupt number INTR_NUM at step 938.

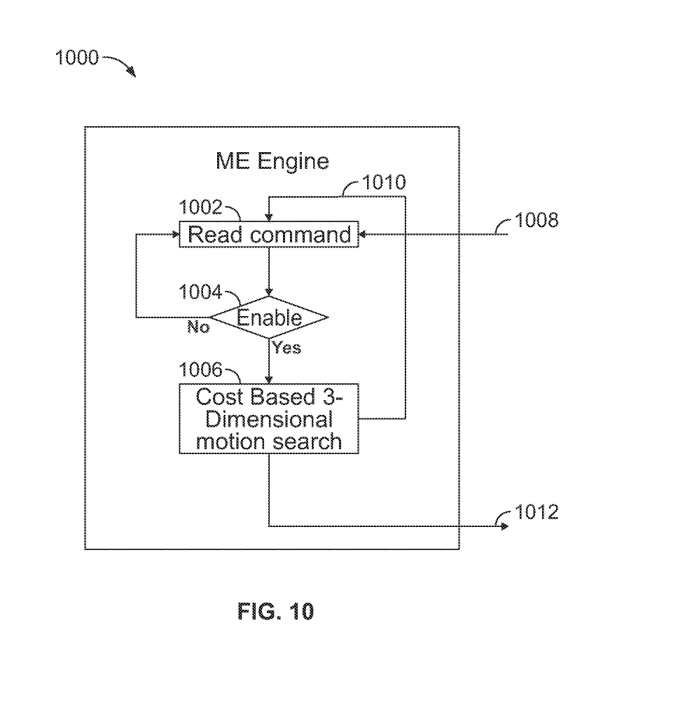

Referring to FIG. 10 is a diagram 1000 depicting the task executed in a motion estimation engine. According to a non limiting exemplary embodiment of the present subject matter, the data or commands transferred to the motion estimation engine are received by the read command 1002 on receiving a start command 1008 and also through an output configured from the cost based 3-dimensional motion search 1006. The commands read are further enabled by the enable 1004 and transmitted to the cost based 3-dimensional motion search 1006 for calculating the rate distortion cost value and commands which are not enabled are transmitted back to the read command 1002. An interrupt 1012 is provided to the host device after calculating the rate distortion cost and the control goes back to the read command 1002 after completing the motion estimation.

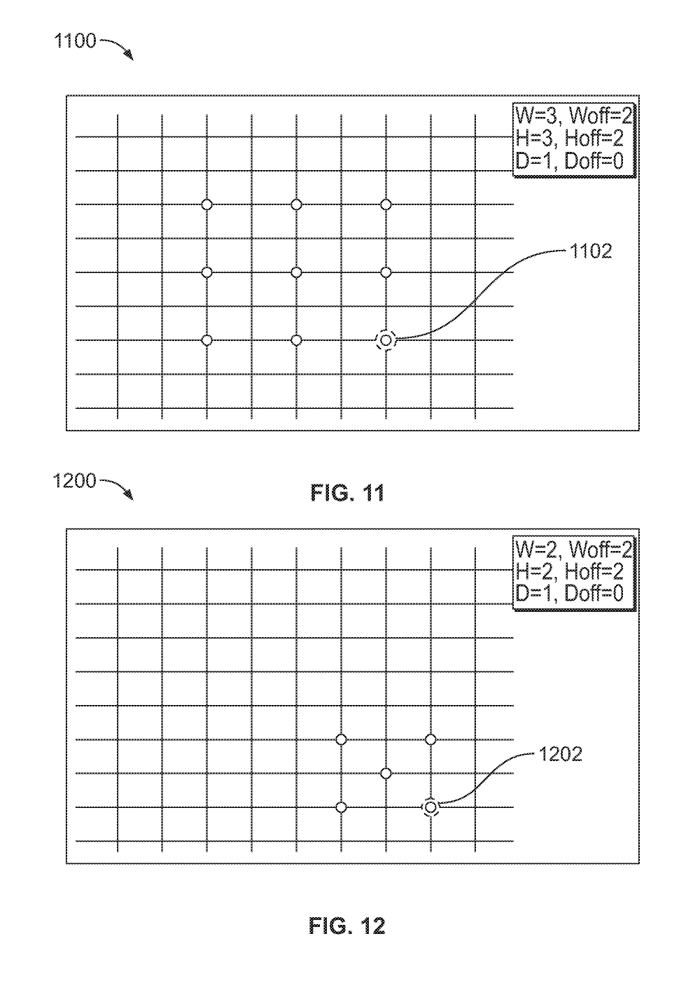

Referring to FIG. 11 is a diagram 1 100 depicting the first step of a motion estimation search in first case. In accordance with a non limiting exemplary implementation of the present subject matter, the best search point is calculated by the N-stage motion search in two different cases where each case is analysed in two steps. The best search point 1102 in first step of first case of pixel partition which is calculated by assigning the number of steps in width and number of steps in vertical as three (W=3 and H=3), number of steps in depth as one (D=1), width offset in terms of pixels and height offset in terms of lines are considered as two (woff=2 and Hoff=2) and depth offset in terms of pixels as zero (Doff=0).

Referring to FIG. 12 is a diagram 1200 depicting the second step of a motion estimation search in first case. In accordance with a non limiting exemplary implementation of the present subject matter, the best search point is calculated by the N-stage motion search in two different cases where each case is analysed in two steps. The best search point 1202 in second step of first case of sub pixel partition which is calculated from the best search point of step 1 by assigning the number of steps in width and number of steps in vertical as two (W=2 and H=2), number of steps in depth as one (D=1), width offset in terms of pixels and height offset in terms of lines are considered as two (woff=2 and Hoff=2) and depth offset in terms of pixels as zero (Doff=0). Thus in 1st case the best minimum point is identified by analysing the two iterations.

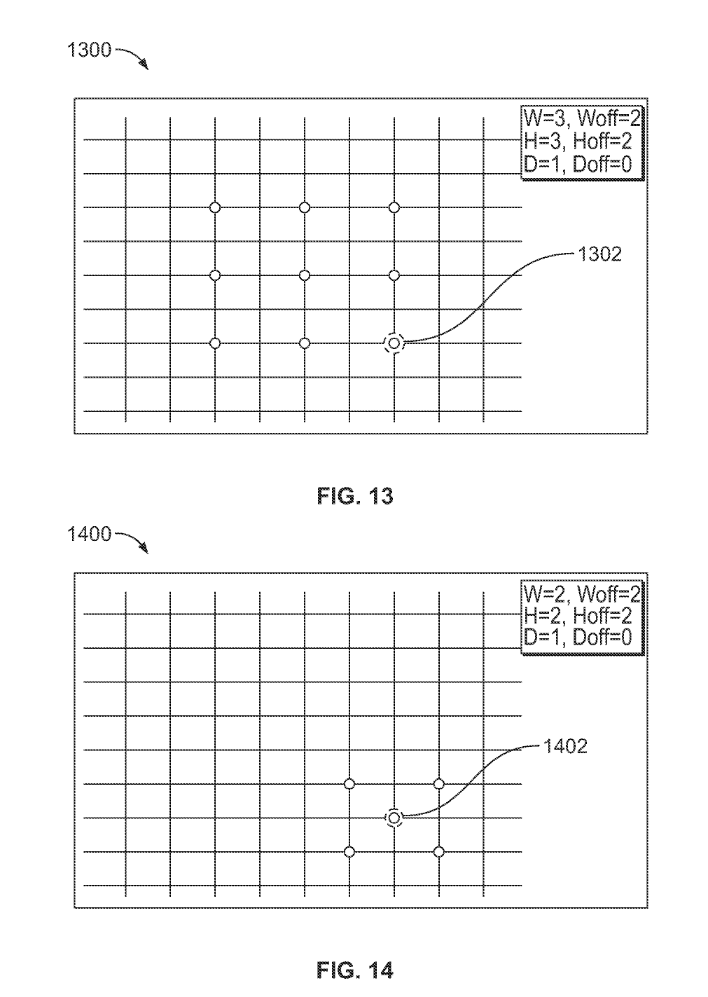

Referring to FIG. 13 is a diagram 1300 depicting the first step of a motion estimation search in second case. In accordance with a non limiting exemplary implementation of the present subject matter, the best search point is calculated by the N-stage motion search in two different cases where each case is analysed in two steps. The best search point 1302 in first step of second case of pixel partition which calculated by assigning the number of steps in width and number of steps in vertical as three (W=3 and H=3), number of steps in depth as one (D=1), width offset in terms of pixels and height offset in terms of lines are considered as two (woff=2 and Hoff=2) and depth offset in terms of pixels as zero (Doff=0).

Referring to FIG. 14 is a diagram 1400 depicting the second step of a motion estimation search in second case. In accordance with a non limiting exemplary implementation of the present subject matter, the best search point is calculated by the N-stage motion search in two different cases where each case is analysed in two steps. The best search point 1402 in second step of second case of sub pixel partition which is calculated from the best step search point of step 1 by assigning the number of steps in width and number of steps in vertical as two (W=2 and H=2), number of steps in depth as one (D=1), width offset in terms of pixels and height offset in terms of lines are considered as two (woff=2 and Hoff=2) and depth offset in terms of pixels as zero (Doff=0). Thus in the second case the best minimum point is not identified by analysing the two iterations so further the iteration is to be continued for N-stages to find the best minimum point.

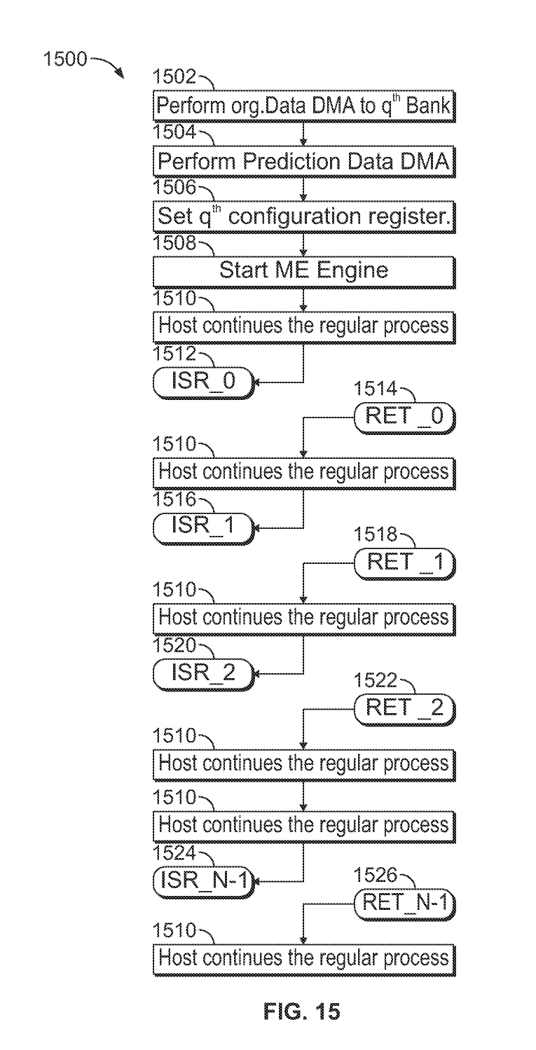

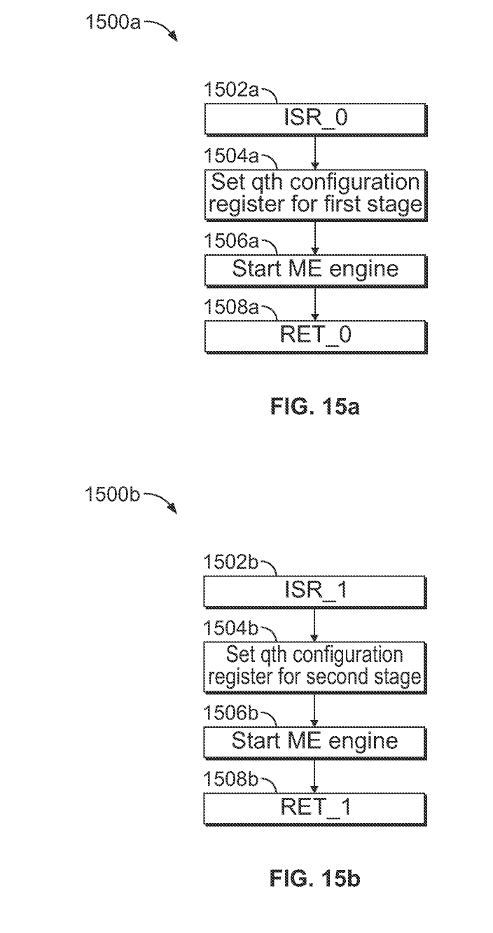

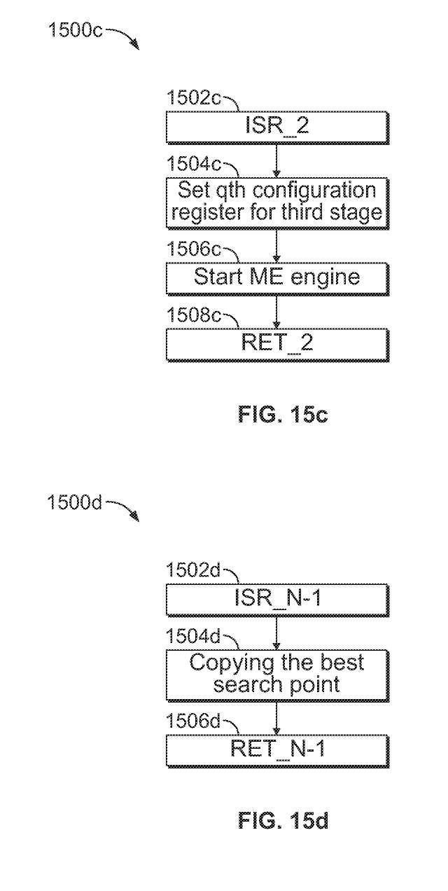

Referring to FIG. 15 is a flow diagram 1500 depicting the N-stage motion search in a host processor using motion estimation engine. According to a non limiting exemplary embodiment of the present subject matter, the flow diagram 1500 depicts about the process of motion estimation engine in N-stages to calculate the best search point.

In accordance with a non limiting exemplary implementation of the present subject matter, the method of performing an N-stage motion search includes a step 1502 for receiving the original data from a direct memory access to the qth bank configured in the motion estimation engine. At step 1504, the prediction data is transferred to internal memory of host using DMA. At step 1506, the qth configuration register set includes 8 different sum of absolute difference (SAD) configuration input/output register sets in the motion estimation engine which are initially set at step 0 by assigning the reset register value to one (SAD_RESET=1) and the sum of absolute difference interrupt service routine number to interrupt service routine at zero (SAD_INTR_NUM=ISR_{—}0).

According to a non limiting exemplary embodiment of the present subject matter, at step 1508 the motion estimation engine starts the process of searching the best search point. The process of executing the motion estimation engine depends upon the values set in the qth configuration registers, according to the step 1506 the reset register is set to one which determines that the entire state information of motion estimation engine which is being set to a default state and the motion estimation engine's interrupt service routine number as interrupt service routine at zero. At step 1510, the host communicating with the motion estimation engine continues the regular process while the motion estimation engine performs its specified actions. At step 1512, the motion estimation engine calls an interrupt service routine for initial step at step 0 to perform respective actions at step 1502a described in FIG. 15a and returns the value of that particular step-0 by providing an interrupt 1514 to the host processor. The host processor receives the interrupt value and continues its regular process at step 1510. The motion estimation engine again calls the interrupt service routine for processing the step-1 at step 1516 to perform the specific action at step 1502b in the FIG. 15b and returns the value after completing the motion estimation process at step 1508b of FIG. 15b to the host processor by providing an interrupt at step 1518. Thus the host processor receives the interrupt value and continues its regular process at step 1510.

In accordance with a non limiting exemplary implementation of the present subject matter, at step 1520 the motion estimation engine again calls the sum of absolute interrupt service routines for processing the step-2 to perform the specific action at step 1502c in FIG. 15c and returns the value after completing the motion estimation process at step 1508c of FIG. 15c to the host processor by providing an interrupt at step 1522 and further the host processor receives the interrupt value and continues its regular process at step 1510. Similarly the process continues for N-stages to calculate the best search point further the motion estimation engine calls the interrupt service routine for Nth stage at step 1524 for processing the step-N−1 to perform the specific action at step 1502d in FIG. 15d and then returns the value after completing the motion estimation process at step 1506d of FIG. 15d to the host processor by providing an interrupt at step 1526 to the host processor and continues the regular process at step 1510.

Referring to FIG. 15a is a flow diagram 1500a depicting the interrupt service routine for the first stage of motion search. According to a non limiting exemplary embodiment of the present subject matter, the flow diagram 1500a depicts about the interrupt called for the first stage of motion search.

In accordance with a non limiting exemplary implementation of the present subject matter, the method of performing interrupt service routine for first stage motion search starts at step 1502a for the called interrupt service routine number at step 1512 of FIG. 15. The qth configuration register set including 8 different sum of absolute difference (SAD) configuration input/output register sets in the motion estimation engine are set at step 1504a by assigning the reset register value to zero (SAD_RESET=0) so that the motion estimation engine considers the previous information of minimum rate distortion cost, minimum sum of absolute difference value, address of the best search point and motion vector information of the best search point for performing the present motion estimation process. And the sum of absolute difference interrupt service routine number is assigned with the next step of interrupt number as ISR 1 and starts the motion estimation engine process for searching the best search point at step 1506a. Further the process of executing motion estimation engine depends upon the values set in the set of qth configuration registers in step 1504a. Thus the best search point value obtained from the motion estimation process is returned to the host processor at step 1508a by providing an interrupt for the host processor at step 1514 of FIG. 15.

Referring to FIG. 15b is a flow diagram 1500b depicting the interrupt service routine for the second stage of motion search. According to a non limiting exemplary embodiment of the present subject matter, the flow diagram 1500b depicts about the interrupt called for the second stage of motion search.

In accordance with a non limiting exemplary implementation of the present subject matter, the method of performing interrupt service routine for the second stage of motion search starts at step 1502b for the called interrupt service routine number at step 1516 of FIG. 15. The qth configuration register set including 8 different sum of absolute difference (SAD) configuration input/output register sets in the motion estimation engine are set at step 1504b by assigning the reset register value to zero (SAD_RESET=0) and the sum of absolute difference interrupt service routine number to the next step of interrupt number as ISR 2 and starts the motion estimation engine process for searching the best search point at step 1506b. Further the process of executing motion estimation engine depends upon the values set in the set of qth configuration registers in step 1504b. Thus the best search point value obtained from the motion estimation process is returned to the host processor at step 1508b by providing an interrupt for the host processor at step 1518 of FIG. 15.

Referring to FIG. 15c is a flow diagram 1500c depicting the interrupt service routine for the third stage of motion search. According to a non limiting exemplary embodiment of the present subject matter, the flow diagram 1500c depicts about the interrupt called for the third stage of motion search.

In accordance with a non limiting exemplary implementation of the present subject matter, the method of performing interrupt service routine for the third stage motion search starts at step 1502c for the called interrupt service routine number at step 1520 of FIG. 15. The qth configuration register set including 8 different sum of absolute difference (SAD) configuration input/output register sets in the motion estimation engine are set at step 1504c by assigning the reset register value to zero (SAD_RESET=0) and the sum of absolute difference interrupt service routine number to the next step of interrupt number as ISR 3 and then starts the motion estimation engine process for searching the best search point at step 1506c. Further the process of executing motion estimation engine depends upon the values set in the set of qth configuration registers in the step 1504c. Thus the best search point value obtained from the motion estimation process is returned to the host processor at the step 1508c by providing an interrupt for the host processor at step 1522 of FIG. 15. Similarly the process of executing the interrupt service routine for N−1 stages continues to calculate the best search point.

Referring to FIG. 15d is a flow diagram 1500d depicting the interrupt routine at Nth stage motion search. According to a non limiting exemplary embodiment of the present subject matter, the flow diagram 1500d depicts about the interrupt called at Nth stage motion search.

In accordance with a non limiting exemplary implementation of the present subject matter, the method of performing interrupt service routine at Nth stage motion search starts at step 1502d for the called interrupt service routine number at step 1524 in FIG. 15. The best search point information is copied from the qth configuration register set after performing the N-stage motion search at step 1504d and the copied best search point value is returned to the host processor at the step 1506d by providing an interrupt to the host processor at step 1526 of FIG. 15. Similarly the best search point can be calculated for N-stage motion search of n*n partition modes including but not limited to 16×16 partition mode, 16×8 partition mode, 8×16 partition mode, 8×8 partition mode and the like.

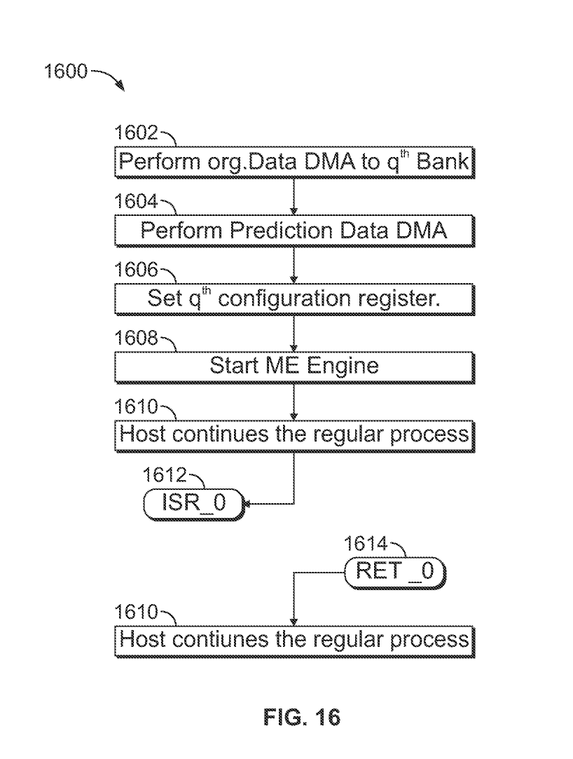

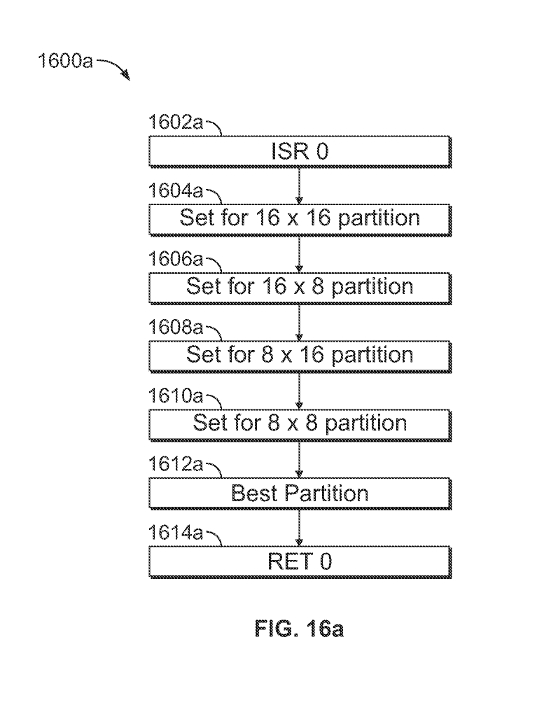

Referring to FIG. 16 is a flow diagram 1600 depicting the process of finding the best partition. When motion estimation engine is configured in a 16×16 mode. According to a non limiting exemplary embodiment of the present subject matter, the flow diagram 1600 depicts about the motion estimation in 16×16 mode to calculate the best search point.

In accordance with a non limiting exemplary implementation of the present subject matter, the method of performing the motion estimation engine in 16×16 mode starts at step 1602 for receiving the original data from a direct memory access to the qth bank configured in the motion estimation engine. At step 1604, the prediction data received by the motion estimation engine is transferred to the internal memory of the host processor using DMA controller. At step 1606, the qth configuration register set includes 8 different configuration input/output register sets in the motion estimation engine which are set to mode 0 by assigning the reset register value to one (SAD_RESET=1) and the sum of absolute difference (SAD) interrupt service routine number to interrupt service routine at zero (SAD_INTR_NUM=ISR_{—}0).

According to a non limiting exemplary embodiment of the present subject matter, at step 1608, motion estimation engine starts the process of searching the best search point. The process of executing the motion estimation engine depends upon the values set in the set of qth configuration registers where as in step 1606 the reset register is set to one which determines that the entire state information of motion estimation engine which is being set to a default state and the sum of absolute difference (SAD) interrupt service routine number as interrupt service routine at zero. At step 1610, the host communicating with the motion estimation engine continues the regular process while the motion estimation engine performs its specified actions and calls an interrupt service routine of mode 0 at step 1612 to perform the respective action at step 1602a in FIG. 16a and returns the best search point value at step 1614a of FIG. 16a. Thus the value returned from the sum of absolute interrupt service routines of the mode-0 provides an interrupt to the host processor at step 1614. The interrupt value further received by the host processor continues its regular process at step 1610.

Referring to FIG. 16a is a flow diagram 1600a depicting the interrupt routine of motion estimation engine, when ME engine is configured in 16×16 mode to find out best partition. According to a non limiting exemplary embodiment of the present subject matter, the flow diagram 1600a depicts about the interrupt service routine number at mode 0.

In accordance with a non limiting exemplary implementation of the present subject matter, the method of performing sum of absolute difference interrupt service routines of motion estimation engine in 16×16 mode starts at step 1602a for the called interrupt service routine number of the mode-0 from the step 1612 of FIG. 16. At step 1604a, the best search point information is obtained from the qth register set for 16×16 partition by assigning the minimum rate distortion cost of 16×16 block value to W. At step 1606a, the best search point information is obtained from the qth register set for 16×8 partition by assigning the value to X by adding the minimum rate distortion cost of 16×8 block-0 and the minimum rate distortion cost of 16×8 block-1. At step 1608a, the best search point information is obtained from the qth register set for 8×16 partition by assigning the value to Y by adding the minimum rate distortion cost of 8×16 block-0 and the minimum rate distortion cost of 8×16 block-1 and at step 1610a, the best search point information is obtained from the qth register set for 8×8 partition by assigning the value to Z by adding the minimum rate distortion cost of 8×8 block-0 with the minimum rate distortion cost of 8×8 block-1, the minimum rate distortion cost of 8×8 block-2 and minimum rate distortion cost of 8×8 block-3. At step 1612a, the best search points obtained for each partition are compared to find the best partition P such that P value is assigned by the partitions corresponding to minimum of {W, X, Y, Z} and the best partition obtained by combining all the partitions returns the value to the host processor at step 1614a by providing an interrupt to the host processor at step 1614 of FIG. 16.

Referring to FIG. 17 is a diagram 1700 depicting the process of finding the best match of upper partition and lower partition in a 16×8 mode. According to a non limiting exemplary embodiment of the present subject matter, the system includes a predicted data of partition-0 1702a and a predicted data of partition-1 1702b placed anywhere in the memory space to calculate the best search point.

In accordance with a non limiting exemplary implementation of the present subject matter, the system includes a predicted data of first partition-0 1702a and a predicted data second partition-1 1702b in 16×8 mode can be placed at different locations in the memory space. The distance between the predicted data of pixel partitions is called as region offset 1704 which is given through an input configuration register called region offset register. To calculate the best search point of pixel partitions of partition-0 1702a and pixel partitions of partition-1 1702b in a 16×8 mode, the region offset is considered as 17 times the buffer width plus 15 (region offset=17×BW+15) and the number of steps in width and number of steps in vertical are considered as two (W=2 and H=2) and the number of steps in depth is considered as one (D=1). The motion estimation accelerator provides the best match of the upper partition-0 1702a and the best match of the lower partition-1 1702b in a separate set of output configuration registers.

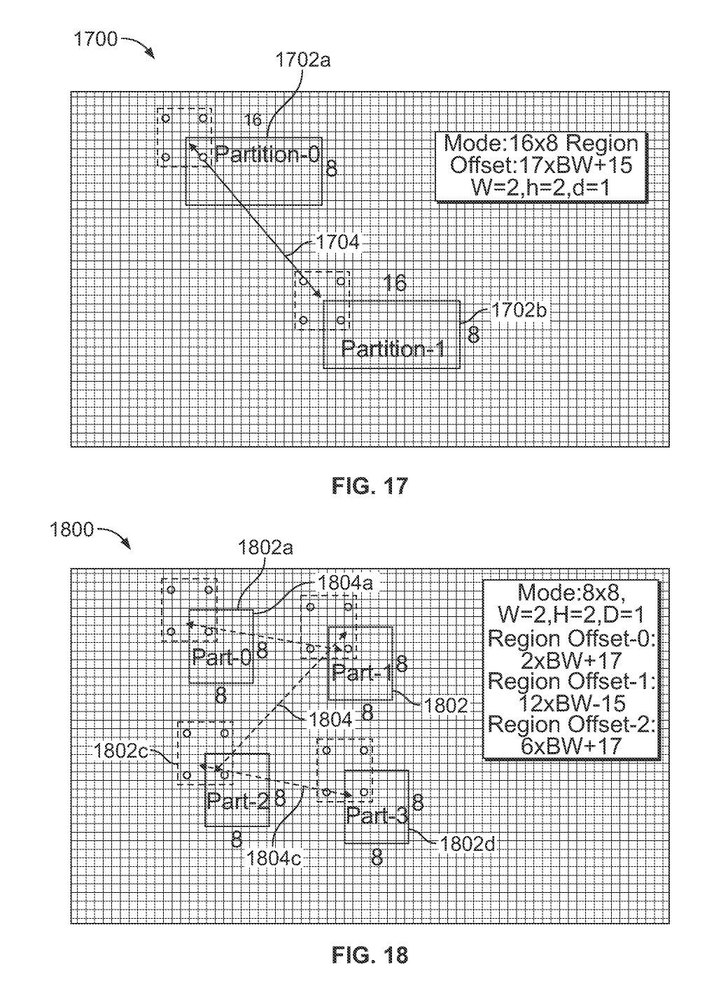

Referring to FIG. 18 is a diagram 1800 depicting the process of finding the best match of sub partitions in an 8×8 mode. According to a non limiting exemplary embodiment of the present subject matter, the system includes sub partitions part-0 1802a, sub partitions part-1 1802b, plurality of sub partitions part-2 1802c and plurality of sub partitions part-3 1802d whose predicted data is placed at different locations to calculate the best search point.

In accordance with a non limiting exemplary implementation of the present subject matter, the predicted data of sub partition part-0 1802a, predicted data of sub partitions part-1 1802b, predicted data of sub partition part-2 1802c and the predicted data of sub partitions part-3 1802d are placed at different memory locations in 8×8 mode and having the number of steps in width and number of steps in vertical as two (W=2 and H=2) and the number of steps in depth is considered as one (D=1). The distance between the predicted data of sub partition part-0 1802a and the predicted data of sub partition part-1 1802b is called the region offset-0 1804a whose value is considered as 2×BW+17. Similarly the distance between the predicted data of sub partition part-1 1802b and the predicted data of sub partition part-2 1802c is called the region offset-1 1804b whose value is considered as 12×BW−15 and also the distance between the predicted data of sub partitions part-2 1802c and the predicted data of sub partition part-3 1802d is called the region offset-2 1804c whose value is considered as 6×BW+17. Thus the motion search of at least one of all the sub partition in 8×8 mode is processed together in a single stretch.

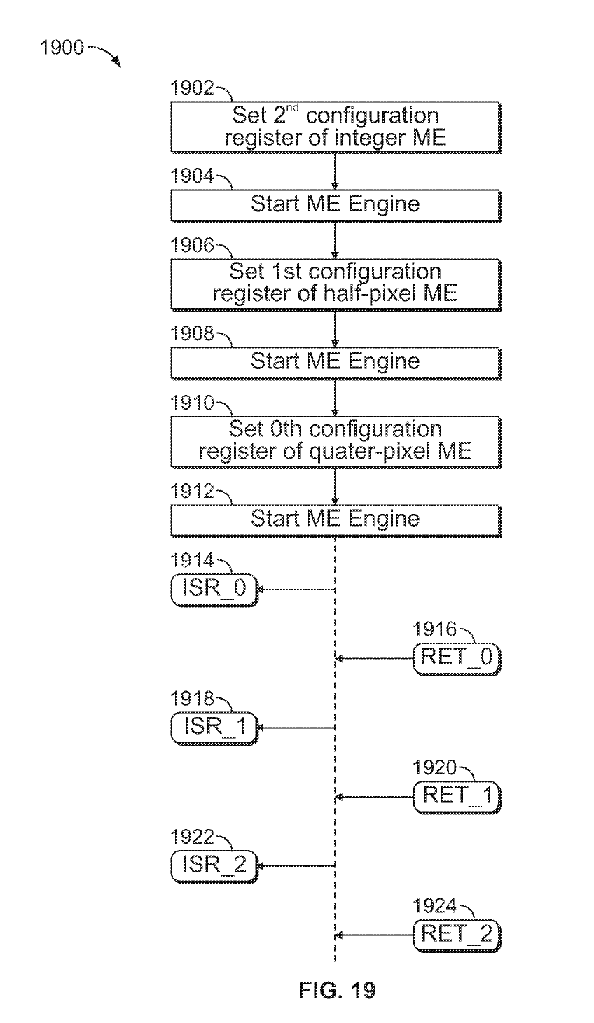

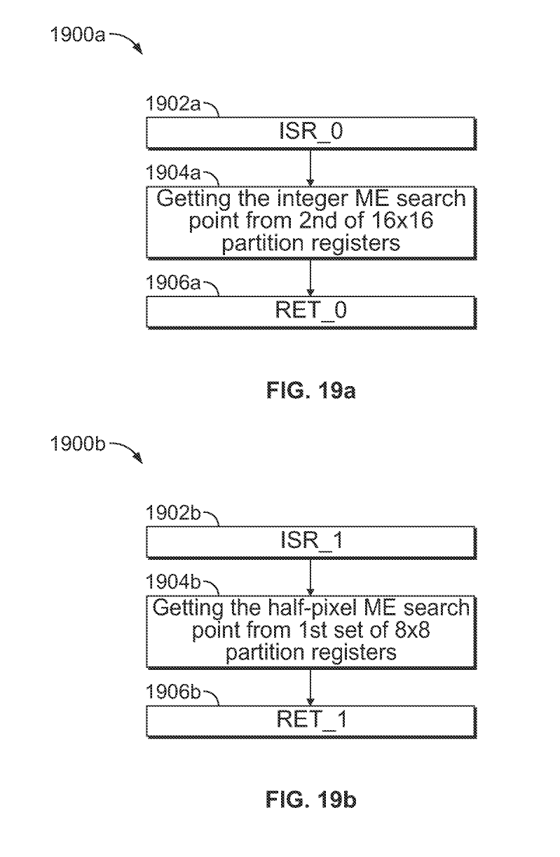

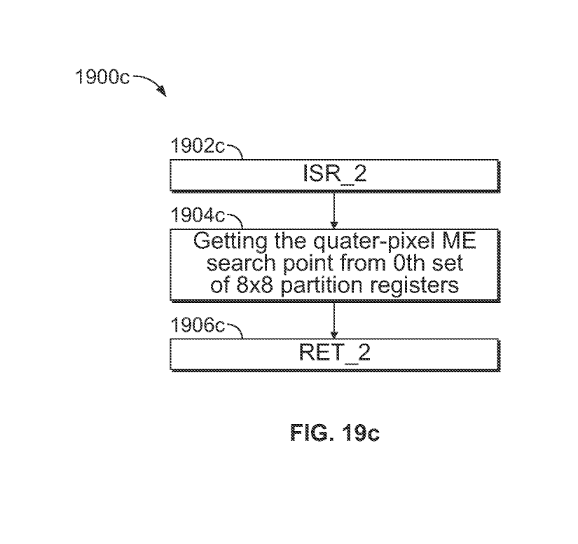

Referring to FIG. 19 is a flow diagram 1900 depicting the process of switching motion estimation engine across 3-pipeline stages of motion estimation in a single macro block time slot. In accordance with a non limiting exemplary implementation of the present subject matter, at step 1902, the second configuration register and the (+2) th macro block's integer-pixel motion estimation process is set by assigning the reset register as one (SAD_RESET=1), interrupt service routine number as zero (SAD_INTR_NUM=ISR_{—}0) and the mode value is set to zero (16×16 mode) and the original data buffer number is set to two (S=2). At step 1904, the motion estimation engine starts the process of searching the best search point depending upon the values set in the second configuration register.

According to a non limiting exemplary embodiment of the present subject matter, at step 1906, the first configuration register and the (N+1)th macro block's half pixel motion estimation process is set by assigning the reset register as one (SAD_RESET=1), interrupt service routine number as one (SAD_INTR_NUM=1) and the mode value is set to three (8×8 mode) and the original data buffer number is set to one (S=1) and starts the motion estimation process at step 1908 to find the best search point depending upon the values set in the 1st configuration register. At step 1910, the 0th configuration register and the Nth macro block's quarter-pixel motion estimation process is set by assigning the reset register as one (SAD_RESET=1), interrupt service routine number as two (SAD_INTR_NUM=ISR_{—}2) and the mode value is set to three (8×8 mode) and the original data buffer number is set to zero (S=0). At step 1912, motion estimation engine starts the process of searching the best search point depending upon the values set in the 2nd configuration register and calls the interrupt service routine number zero at the step 1914 which is discussed in the step 1902a of FIG. 19a. The value obtained from the FIG. 19a at step 1906a returns the value to the motion estimation engine at step 1916.

In accordance with a non limiting exemplary implementation of the present subject matter, at step 1912 the motion estimation engine calls the interrupt service routine number one 1918 which is further discussed in the FIG. 19b at step 1902b. The value obtained at the step 1906b from the FIG. 19b is returned to the motion estimation engine at step 1920 and again at step 1912 the motion estimation engine calls the interrupt service routine number two at step 1922 to perform the specific action which is discussed in the FIG. 19c at step 1902c. The value obtained from the FIG. 19c at step 1906c is returned to the motion estimation engine at step 1924.

Referring to FIG. 19a is a flow diagram 1900a depicting the interrupt routine of motion estimation engine for integer pixel ME pipeline stage. According to a non limiting exemplary embodiment of the present subject matter, the flow diagram 1900a depicts about the interrupt service routine number zero. In accordance with a non limiting exemplary implementation of the present subject matter, the method of performing sum of absolute difference interrupt service routines starts at step 1902a for the interrupt called from the motion estimation engine. At step 1904a, the integer motion estimation best search point information is obtained from the 2nd set of 16×16 partition registers and the best search point value is sent to the return zero (RET 0) at step 1906a which is further transmitted to the motion estimation engine of FIG. 19 through step 1916.

Referring to FIG. 19b is a flow diagram 1900b depicting the interrupt routine of motion estimation engine for half-pixel ME pipeline stage. According to a non limiting exemplary embodiment of the present subject matter, the flow diagram 1900b depicts about the interrupt service routine number one.

In accordance with a non limiting exemplary implementation of the present subject matter, at step 1904b, the half-pixel motion estimation best search point information is obtained from the 1st set of 8×8 partition registers and the best search point value is sent to the return one (RET 1) at step 1906b which is further transmitted to the motion estimation engine of FIG. 19 through step 1920.

Referring to FIG. 19c is a flow diagram 1900c depicting the interrupt routine of motion estimation engine for quarter-pixel ME pipeline stage. According to a non limiting exemplary embodiment of the present subject matter, the flow diagram 1900c depicts about the interrupt service routine number two.

In accordance with a non limiting exemplary implementation of the present subject matter, the method of performing sum of absolute difference interrupt service routines starts at step 1902c for the interrupt called from the motion estimation engine. At step 1904c, the quarter-pixel motion estimation best search point information is obtained from the 0th set of 8×8 partition registers and the best search point value is sent to the return two (RET 2) at step 1906c which is further transmitted to the motion estimation engine of FIG. 19 through step 1924.

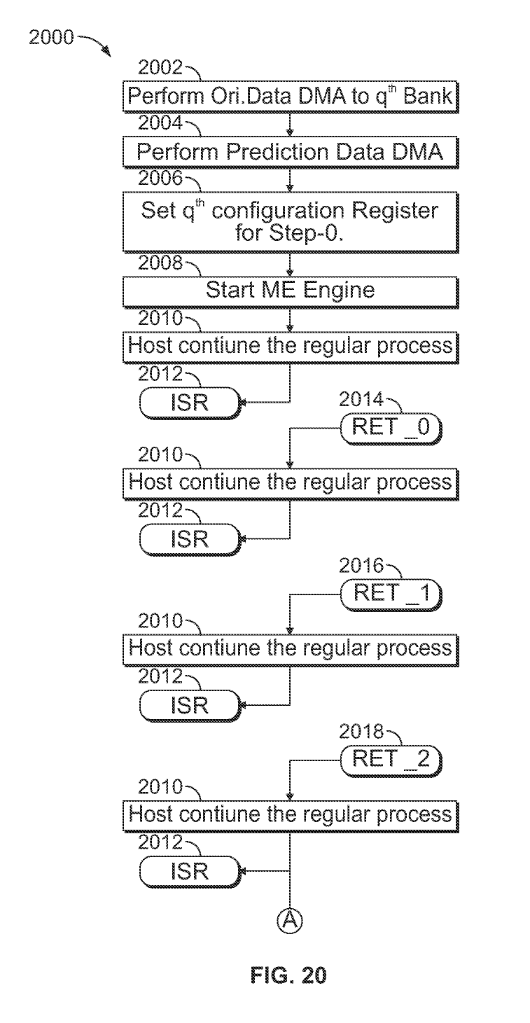

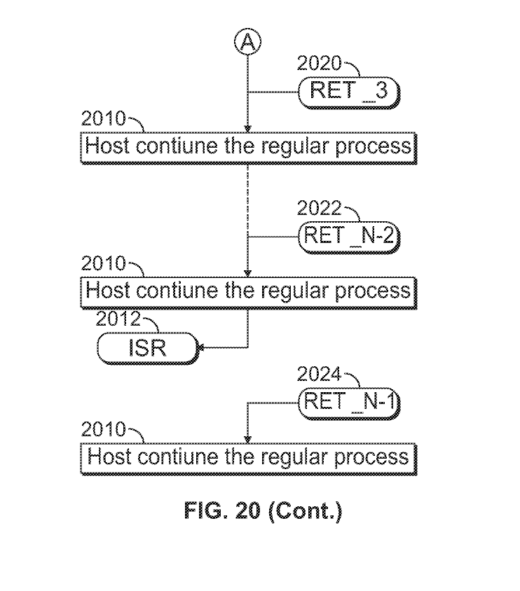

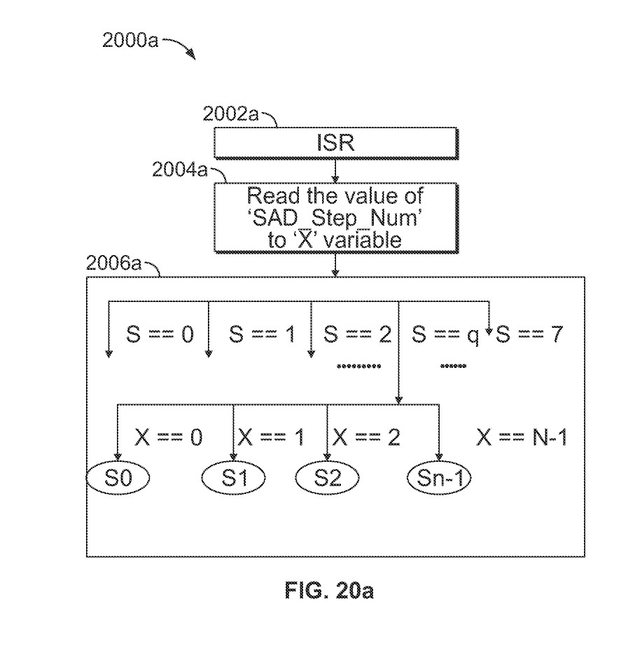

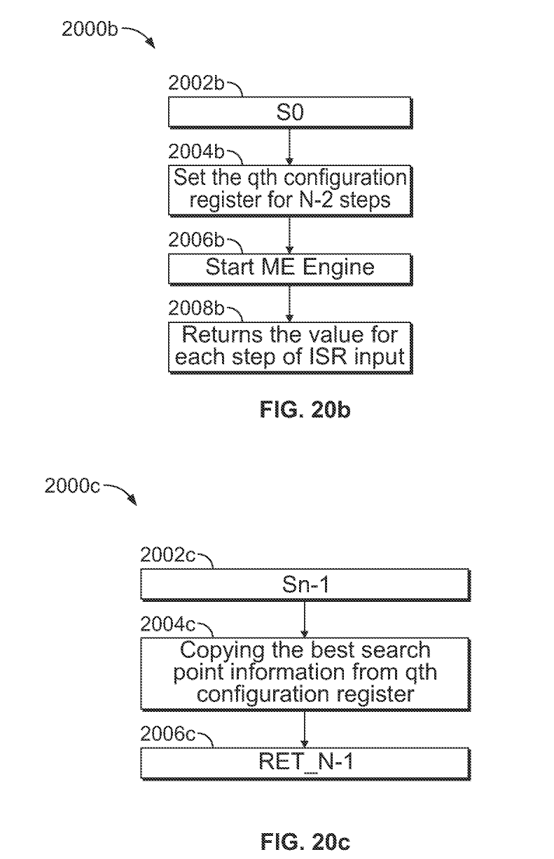

Referring to FIG. 20 is a flow diagram 2000 depicting the process of N-stage motion search when only one interrupt facility is available in a motion estimation engine. According to a non limiting exemplary embodiment of the present subject matter, the flow diagram 2000 depicts about the N-stage motion search with only one interrupt.

In accordance with a non limiting exemplary implementation of the present subject matter, the method of providing a single interrupt for the N-stage motion search in a motion estimation engine starts at step 2002 by receiving the original data from a direct memory access to the qth bank configured in the motion estimation engine. At step 2004, the prediction data received by the motion estimation engine is transferred to the internal memory of the host processor using DMA controller. At step 2006, the qth configuration register set includes 8 different sum of absolute difference (SAD) configuration input/output register sets in the motion estimation engine which are initially set at step 0 by assigning the reset register value to one (SAD_RESET=1) and the sum of absolute difference (SAD) interrupt service routine number as zero (SAD_INTR_NUM=0) and the original data buffer number is equal to q (S=q).

According to a non limiting exemplary embodiment of the present subject matter, at step 2008 the motion estimation engine starts the process of searching the best search point and executes the motion estimation process depending upon the values set in the set of qth configuration registers. The host communicating with the motion estimation engine continues the regular process at step 2010 while the motion estimation engine performs its specific actions and further calls for an interrupt service routine 2002a of FIG. 20a at step 2012 of FIG. 20.

Referring to FIG. 20a is a flow diagram 2000a depicting about the interrupt service routine of an N-stage motion search. According to a non limiting exemplary embodiment of the present subject matter, the flow diagram 2000a depicts about the only one interrupt provided by an N-stage motion search.

In accordance with a non limiting exemplary implementation of the present subject matter, the method of performing interrupt service routine of an N-stage motion search starts at step 2002a for the called interrupt 2012 in FIG. 20. At step 2004a the sum of absolute difference step number set in the qth configuration register of the step 2006 in FIG. 20 is read by the ‘X’ variable and transmitted to the complex state machine at step 2006a to perform the required N-stage motion search at step 2002b of FIG. 20b. In the complex state machine at step 2006a when the original data buffer number is made equal to q (S==q) then the ‘X’ variable is assigned with specified step number to perform the required N-stages of motion search.

Referring to FIG. 20b is a flow diagram 2000b depicting about the N−1 stages of motion search performed by the complex state machine. According to a non limiting exemplary embodiment of the present subject matter, the flow diagram 2000b depicts about the N−1 stages of motion search performed by updating the sum of absolute difference step number.

In accordance with a non limiting exemplary implementation of the present subject matter, the N−1 stages of motion search for each step of complex state starts at step 2002b by assigning the each ‘X’ variable to perform its respective complex states from step-0 to step-N−2. At step 2004b the qth configuration register is set for each state from step-0 to step-N−2 by assigning the reset register value to zero and by incrementing the sum of absolute difference step number for every stage of motion search. Then the motion estimation engine starts its specific actions at step 2006b according to the set qth configuration register values and returns the value of each stage to the step 2008b which is further transmitted to host processor 2010 of FIG. 20 by providing an interrupt for each stage of the called N−1 interrupts.

Referring to FIG. 20C is a flow diagram 2000c depicting about the Nth stage of motion search performed by the complex state machine. According to a non limiting exemplary embodiment of the present subject matter, the N−1 interrupt called by a host processor 2010 of FIG. 20 first performs its specific actions in the FIG. 20a. Further the original data buffer number is made equal to q(S==q) in the complex state machine 2006a of FIG. 20a to execute the respective interrupt step called by the host processor 2010 of FIG. 20. Thus the N−1 interrupt called by the host processor 2010 of FIG. 20 starts at step 2002c and copies the best search point value from the qth configuration register set at step 2004c. Then the obtained best search point value is returned to the step 2006c and transmitted to the host processor 2010 of FIG. 20 by providing an interrupt at step 2024.

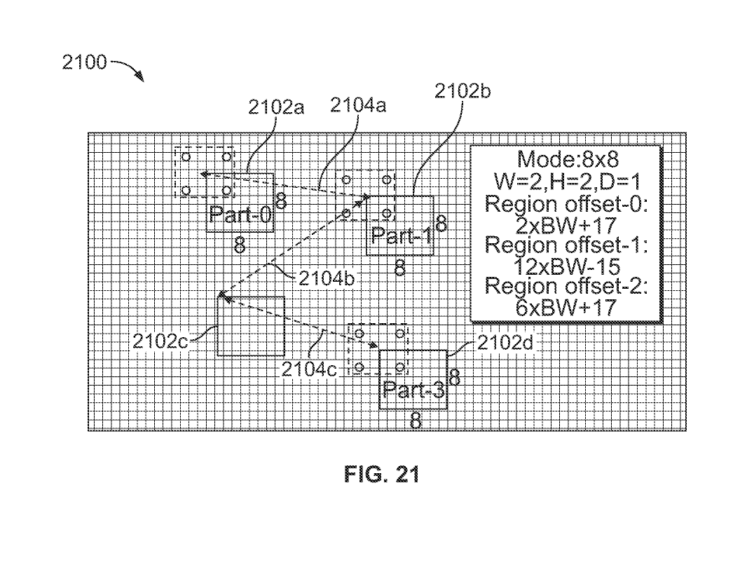

Referring to FIG. 21 is a diagram 2100 depicting the process of activating and deactivating the region based motion search in 8×8 mode. According to a non limiting exemplary embodiment of the present subject matter, diagram 2100 depicts a sub partition part-0 2102a, a sub partition of part-1 2102b, a sub partition of part-2 2102c and a sub partition of part-3 2102d whose predicted data is placed at different memory locations in 8×8 mode to activate and deactivate the required pixel partition.

In accordance with a non limiting exemplary implementation of the present subject matter, the predicted data of sub partition part-0 2102a, predicted data of sub partition in part-1 2102b, predicted data of sub partition in part-2 2102c and the predicted data of sub partition in part-3 2102d are placed at different memory locations in 8×8 mode and having the number of steps in width and number of steps in vertical as two (W=2 and H=2) and the number of steps in depth is considered as one (D=1). The distance between the predicted data of sub partition in part-0 2102a and the predicted data of sub partition in part-1 2102b is called the region offset-0 2104a whose value is considered as 2×BW+17. Similarly the distance between the predicted data of sub partition in part-1 2102b and the predicted data of the sub partition in part-2 2102c is called the region offset-1 2104b whose value is considered as 12×BW−15 and also the distance between the predicted data of sub partition in part-2 2102c and the predicted data of sub in partition part-3 2102d is called the region offset-2 2104c whose value is considered as 6×BW+17. The sub partitions placed at different locations are activated and deactivated while processing the motion estimation.

According to a non limiting exemplary embodiment of the present subject matter, the sub partition in part-2 2102c is deactivated and the remaining sub partitions part-0 2102a, part-1 2102b and part-3 2102d are activated to process the motion search patterns of motion estimation engine. The process of activating and deactivating the pixel partitions is done through a configuration register.

While specific embodiments of the invention have been shown and described in detail to illustrate the inventive principles, it will be understood that the invention may be embodied otherwise without departing from such principles.

What is claimed is:

1. A method of performing motion estimation search utilizing a motion estimation accelerator in a video processing systems, the method comprising:
transmitting an original pixel data to at least one memory bank of a motion estimation engine, whereby the motion estimation engine calculates a best search point among a predicted pixel data;
calculating a distortion value between the original pixel data and a predicted pixel data by a sum of absolute difference engine configured in the motion estimation engine;
analyzing the distortion value and a plurality of predefined parameters by an analyzer configured in the motion estimation engine to obtain a minimum rate distortion cost, whereby the analyzer configured to: add a cost factor and a plurality of parameters to the distortion value calculated by the sum of absolute difference engine; perform a cost based search in a plurality of pixel partition modes of a cost factor added pixel data; conducting an n stage motion estimation of a plurality of sub partitions corresponding to the plurality of pixel partition in a single stretch; seamlessly switch across different pipeline stages of the motion estimation process in single pixel partition; and providing a best search point of subsequent pixel partitions associated to the plurality of pixel partitions.

2. The method of claim 1 comprising a step of generating a user specified interrupt signal to a host processor by the motion estimation accelerator.

3. The method of claim 1, comprising a step of inputting the plurality of predefined parameters from a plurality of input registers to obtain a minimum rate distortion cost.

4. The method claim 1, comprising a step of transmitting the minimum rate distortion cost to the host processor through a plurality of output registers.

5. The method of claim 1, comprising a step of supporting a maximum number of vertical dimensions and a maximum number of depth dimensions to calculate the cost factor by at least one cost array register.

6. The method of claim 1, comprising a step of supporting the maximum number of depth dimensions to calculate the cost factor by at least one cost offset register.

7. The method of claim 1, comprising a step of calculating a distance between two pixel partitions by the input register.

8. The method of claim 1, comprising a step of activating and deactivating at least one sub partitions among the plurality of pixel partitions.

9. The method of claim 8, comprising a step of performing a plurality of iterations to find a best motion search point of an activated pixel partition.

10. A method of performing motion estimation search in a motion estimation accelerator, the method comprising, comprising:
transmitting an original pixel data to at least one memory bank of the motion estimation engine, whereby the motion estimation engine calculates a best search point of the original pixel data received from a direct memory access;
calculating a distortion value between the original pixel data and a predicted pixel data through a sum of absolute difference engine configured in the motion estimation engine, whereby the sum of absolute difference engine receives the predicted pixel data from an internal memory of a host through a prediction data bus communicating between the sum of absolute difference engine and the host;
analyzing the distortion value and a plurality of predefined parameters by an analyzer configured in the motion estimation engine to obtain a minimum rate distortion cost, whereby the plurality of predefined parameters inputted through a plurality of input registers and the minimum rate distortion cost obtained from analyzing the distortion value and the plurality of predefined parameters are transmitted through a plurality of output registers to the analyzer; and
generating a user specified interrupt signal to the host processor after completing the motion estimation search, whereby the host processor configured to receive the interrupt signal from the analyzer configured in the motion estimation engine.

11. The method of claim 10, comprising a step of adding a cost factor and a plurality of parameters to the distortion value calculated by the sum of absolute difference engine.

12. The method of claim 10, comprising a step of performing a cost based search in a plurality of pixel partition modes of a cost factor added pixel data.

13. The method of claim 10, comprising a step of conducting an n stage motion estimation of a plurality of sub partitions corresponding to the plurality of pixel partition in a single stretch.

14. The method of claim 10 comprising a step of providing a best search point of subsequent pixel partitions associated to the plurality of pixel partitions

15. The method of claim 10, comprising a step of seamlessly switching across the different pipeline stages of the motion estimation process in a single pixel partition.

16. A motion estimation accelerator configured to perform a motion estimation search in a video encoder comprising: a memory bank configured in the motion estimation engine receives an original pixel data for calculating the best search point;
a sum of absolute difference engine configured in the motion estimation engine to calculate a distortion value between the original pixel data and a predicted pixel data;
an analyzer configured to analyze the best search point by calculating the minimum rate distortion cost, whereby the minimum rate distortion cost is calculated by adding the cost factor and a plurality of predefined parameters to a distortion value;
an input register configured in the motion estimation engine for transmitting the plurality of predefined parameters to the analyzer for calculating the minimum rate distortion cost, whereby the plurality of predefined parameters and a cost factor are added to the distortion value by the analyzer; and
an output register configured in the motion estimation engine for transmitting the minimum rate distortion cost.

17. The motion estimation accelerator of claim 16, further comprises a direct memory access connected to the motion estimation engine for transmitting the original pixel data to the plurality of memory banks.

18. The motion estimation accelerator of claim 16, wherein a host transmits the predicted pixel data to the sum of absolute difference engine through a prediction data bus.

19. The motion estimation accelerator of claim 18, wherein the host further transmits the minimum rate distortion cost to the host through the plurality of output registers configured in the motion estimation engine.

20. The motion estimation accelerator of claim 18, wherein further generates a user specified interrupt to the host from analyzer configured in the motion estimation engine.
